(19) United States
(12) Patent Application Publication
(10) Pub. No.: US 2013/0070926 A1
(43) Pub. Date: Mar. 21, 2013

(54) TERMINAL AND METHOD FOR COMMUNICATING VIA NEAR FIELD COMMUNICATION

(71) Applicant: Jong Hyuk EUN, Seoul (KR)

(72) Inventor: Jong Hyuk EUN, Seoul (KR)

(73) Assignee: PANTECH CO., LTD., Seoul (KR)

(21) Appl. No.: 13/617,892

(22) Filed: Sep. 14, 2012

(30) Foreign Application Priority Data
Sep. 19, 2011 (KR) 10-2011-0093973

(51) Int. Cl. H04B 5/02; H04L 9/00

(52) U.S. Cl. 380/270; 455/11.1

(57) ABSTRACT

A near field communication (NFC) terminal includes: a NFC communication unit to communicate with a NFC communication relay device via NFC; a processor to process data; and a protocol information unit, wherein the NFC communication unit communicates the data and the profile information via to the NFC communication relay device via NFC. A method includes: at a NFC communication relay device, receiving data augmented with profile information; storing the data augmented with profile information; retrieving the data based on a request from the second NFC terminal; and transmitting the data to the second NFC terminal. A NFC relay device, includes: a processor to process data; an information storage unit to store the received data, wherein if the NFC relay device receives a request from a NFC terminal, the processor retrieves data from the information unit, and the NFC transmitter transmits the data to the NFC terminal.

### CROSS-REFERENCE TO RELATED APPLICATION

This application claims priority from and the benefit under 35 U.S.C. §119(a) of Korean Patent Application No. 2011-0093973, filed on Sep. 19, 2011, which is incorporated by reference for all purposes as if fully set forth herein.

### BACKGROUND

1. Field

Exemplary embodiments of the present invention relate to a terminal and method for communicating via near field communication (NFC) terminals and, more particularly, to a terminal and method for communicating via NFC utilizing a NFC communication relay device.

2. Discussion of the Background

Near field communication (NFC) is based on communication accomplished via radio frequency identification (RFID), and allows the transmission of data between terminals using a non-contact NFC using a frequency band of 13.56 MHz at a close distance of 10 cm.

Smart terminals, such as a smart phone or a smart pad, have been implemented with NFC capabilities, by mounting modules for NFC on the smart phones or a smart pads.

FIG. 1 is a diagram illustrating a method for communicating between NFC terminals according to the prior art.

If two NFC terminals, including a transmission terminal 10 and a reception terminal 20 exchange information, the reception terminal 20 transmits a public key thereof to the transmission terminal 10 (S10).

The reception terminal 20 has a private key that is a pair with the public key, and the public key is transmitted from the reception terminal 20 to the transmission terminal 10 in operation S10.

The transmission terminal 10 generates and encrypts a symmetrical key using the public key received from the reception terminal 20 (S12), and transmits the encrypted symmetrical key to the reception terminal 20 (S14).

The reception terminal 20 decodes the encrypted symmetrical key received from the transmission terminal 10 using the private key (S16), and the transmission terminal 10 encrypts data using a symmetrical key (S18) if it is determined that the reception terminal 20 receives the encrypted symmetrical key. The encrypted data is transmitted to the reception terminal 20 (S20).

The reception terminal 20 decodes the encrypted data received from the transmission terminal 10 using the symmetrical key (S22).

As described above, in the case where the two NFC terminals exchange information, the information is transmitted and received using the public key. However, since the two terminals are located at the same place at the same time, an information transmission range is narrow.

In addition, in the case where information is transmitted using the public key, a transmission of the public key, and generating and sharing the symmetrical key is performed in advance.

### SUMMARY

Exemplary embodiments of the present invention provide a near field communication (NFC) terminal and a method for communication between NFC terminals. Specifically, exemplary embodiments relate to facilitating NFC terminal communication along with the use of a NFC relay communication device.

Additional features of the invention will be set forth in the description which follows, and in part will be apparent from the description, or may be learned by practice of the invention.

An exemplary embodiment of the present invention discloses a near field communication (NFC) terminal, including: a NFC communication unit to communicate with a NFC communication relay device via NFC; a processor to process data; and a protocol information unit to augment the data with a profile information, wherein the NFC communication unit communicates the data and the profile information via to the NFC communication relay device via NFC.

An exemplary embodiment of the present invention discloses a method for providing communication between a first near field communication (NFC) terminal and a second NFC terminal, comprising: at a NFC communication relay device, receiving data augmented with profile information; at the NFC communication relay device, storing the data augmented with profile information; at the NFC communication relay device, retrieving the data based on a request from the second NFC terminal; and at the NFC communication relay device, transmitting the data to the second NFC terminal.

An exemplary embodiment of the present invention discloses a near field communication (NFC) relay device, including: a NFC receiver to receive data and protocol information via NFC communication; a NFC transmitter to transmit data via NFC communication; a processor to process data; an information storage unit to store the received data, wherein if the NFC relay device receives a request from a NFC terminal, the processor retrieves data from the information unit, and the NFC transmitter transmits the data to the NFC terminal.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram illustrating a method for communicating between NFC terminals according to the prior art.

FIG. 2 is a schematic diagram illustrating a system of NFC terminals according to an exemplary embodiment of the present invention.

FIG. 3 is a schematic diagram illustrating NFC data according to an exemplary embodiment of the present invention.

FIG. 4 is a schematic diagram illustrating NFC data according to an exemplary embodiment of the present invention.

FIG. 5 is a schematic diagram illustrating NFC data according to an exemplary embodiment of the present invention.

FIG. 6 is a schematic diagram illustrating a NFC terminal according to an exemplary embodiment of the present invention.

FIG. 7 is a schematic diagram illustrating a protocol information unit according to an exemplary embodiment of the present invention.

FIG. 8 is a schematic diagram illustrating a NFC communication relay device according to an exemplary embodiment of the present invention.

FIG. 9 is a flowchart illustrating a method for communicating between NFC terminals according to an exemplary embodiment of the present invention.

FIG. 10 is a flowchart illustrating a method for communicating between NFC terminals according to an exemplary embodiment of the present invention.

FIG. 11 is a flowchart illustrating a method for communicating between NFC terminals according to an exemplary embodiment of the present invention.

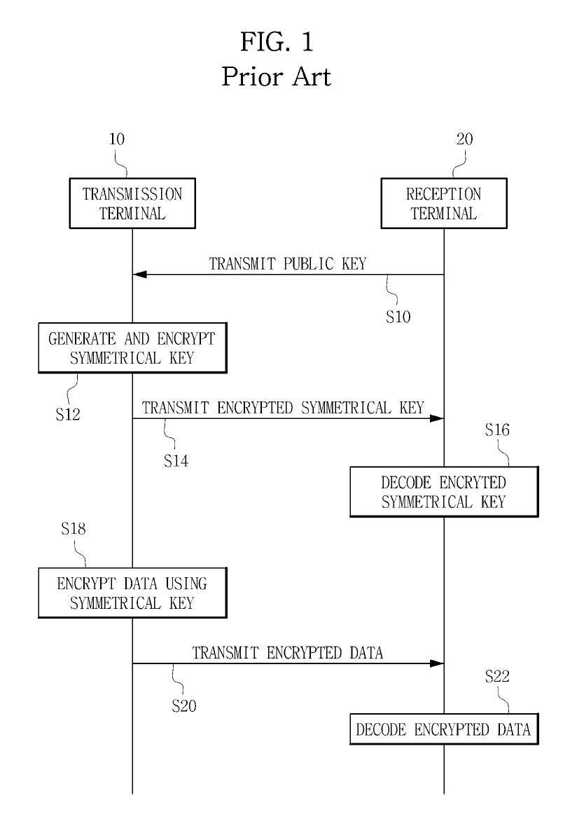

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION OF THE ILLUSTRATED EMBODIMENTS

Exemplary embodiments now will be described more fully hereinafter with reference to the accompanying drawings, in which exemplary embodiments are shown. The present disclosure may, however, be embodied in many different forms and should not be construed as limited to the exemplary embodiments set forth therein. Rather, these exemplary embodiments are provided so that the present disclosure will be thorough and complete, and will fully convey the scope of the present disclosure to those skilled in the art. In the description, details of well-known features and techniques may be omitted to avoid unnecessarily obscuring the presented embodiments.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

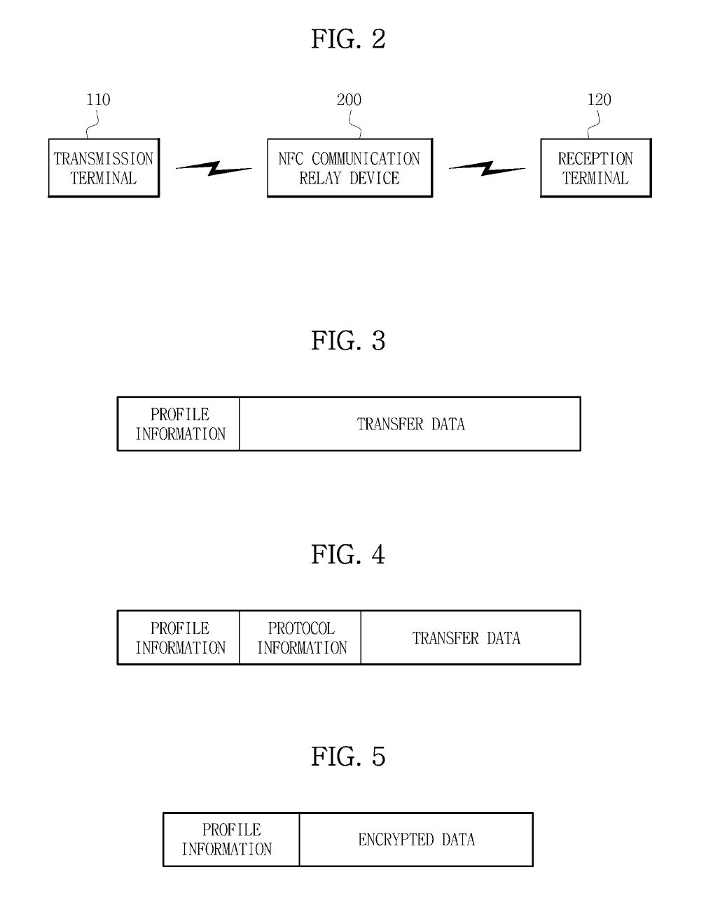

FIG. 2 is a schematic diagram illustrating a system of NFC terminals according to an exemplary embodiment of the present invention.

In FIG. 2, a transmission terminal 110 processes data to be transmitted to a reception terminal 120 using profile information of the reception terminal 120, and generates NFC data. The generated NFC data is transmitted via a NFC communication relay device 200 with NFC communication.

The profile information contains information about identification of the reception terminal 120, and may be stored in the transmission terminal 110. For example, the profile information may be a telephone number of the reception terminal 120, and may be stored in an address book of the transmission terminal 110, a serial number of the reception terminal 120, or a name, a nickname, an email address and an address of a user of the reception terminal 120. Throughout this disclosure, profile information may include information about a single reception terminal. However, if there are multiple reception terminals, the profile information may contain information about the multiple reception terminals or each reception terminal may have its own separate profile information.

The profile information may be obtained from the address book stored in an information storage unit (not shown) of the transmission terminal 110 or a protocol information unit 103.

The transmission terminal 110 may process and generate data and protocol information to restrict transmission and execution of the data to be transmitted, for example, by using the profile information of the reception terminal 120. This may be done prior to the transmission of the NFC data.

The NFC communication relay device 200 stores the NFC data received from the transmission terminal 110, retrieves the data to be transmitted to the reception terminal 120 using the profile information, and transmits the retrieved data to the reception terminal 120.

The reception terminal 120 may request data from the NFC communication relay device 200, and receives data from the NFC communication relay device 200 as a response thereto.

In the case where protocol information is included in the data received from the transmission terminal 110, the NFC communication relay device 200 may restrict transmission of the data to the reception terminal 120 based on the protocol information. For example, if a time that the reception terminal 120 requests the data exceeds a time included in the protocol information, transmission of the data to the reception terminal 120 is restricted.

In the case where the transmission terminal 110 transmits protocol information with a transmission restriction time (or transmission restriction number), the NFC communication relay device 100 may delete or restrict the transmission of data if the restriction time (or the restriction number) is met or exceeded.

If the protocol information is mapped to the data transmitted from the NFC communication relay device 200, and is executed according to a terminal user request, the reception terminal 120 may restrict execution of the data based on information associated with the mapped protocol information. For example, the protocol information dictates that the data is executed at a specific position (e.g., in an office), the reception terminal 120 may restrict execution of the data if the terminal user requests to execute the data at a place (e.g., outside the office) that differs from the specific position.

The transmission terminal 110 encrypts the data, processes the encrypted information using the profile information of a reception terminal 120 that receives the encrypted data, transmits the processed information to the NFC communication relay device 200 with NFC communication, and transmits a decoding key to the reception terminal 120 through a short-range wireless communication technique, such as Bluetooth or ZigBee, a short message service (SMS) or a multimedia message service (MMS). If the transmission terminal 110 transmits the encrypted data to the NFC communication relay device 200, the protocol information may also be transmitted.

The reception terminal 120 requests the data from the NFC communication relay device 200, receives the encrypted data from the NFC communication relay device 200 as a response thereto, and decodes the encrypted data received from the NFC communication relay device 200 using a decoding key received from the transmission terminal 110 through a short-range wireless communication technique, such as Bluetooth or ZigBee, an SMS or a MMS.

FIG. 3 is a schematic diagram illustrating NFC data according to an exemplary embodiment of the present invention.

Referring to FIG. 3, the NFC data includes data to be transmitted from the transmission terminal 110 to the reception terminal 120, and profile data of a reception terminal 120 to receive the data.

FIG. 4 is a schematic diagram illustrating NFC data according to an exemplary embodiment of the present invention.

The NFC data includes data to be transmitted from the transmission terminal 110 to the reception terminal 120, protocol information for restricting transmission and execution of the data according to a parameter, such as time and position, and profile information of a reception terminal 120 to receive the data.

FIG. 5 is a schematic diagram illustrating NFC data according to an exemplary embodiment of the present invention.

The NFC data includes encrypted data and profile information of a reception terminal 120 to receive the encrypted data.

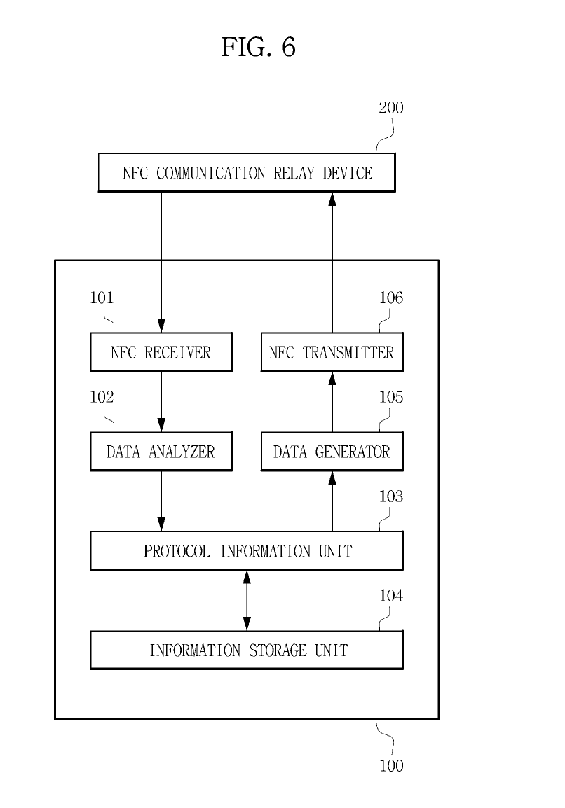

FIG. 6 is a schematic diagram illustrating a NFC terminal according to an exemplary embodiment of the present invention.

In FIG. 6, if the NFC terminal 100 (such as a transmission terminal 110, a reception terminal 120, or the like) requests the data from the NFC communication relay device 200, and the data contains profile information associated with the NFC terminal 100, a NFC receiver 101 receives the data from the NFC communication relay device 200 via NFC communication. The NFC receiver 101 may receive the protocol information from the NFC communication relay device 200, in addition with the data.

The data analyzer 102 analyzes the data received through the NFC receiver 101, and through analysis, may acquire the data and the protocol information.

The protocol information unit 103 processes the protocol information obtained by the data analyzer 102, associates the protocol information to the data, and stores the association, the data and the protocol information in the information storage unit 104.

In the case where a user or a process of the terminal requests execution of the data received through the NFC receiver 101, the protocol information unit 103 may restrict execution of the data based on the protocol information if the protocol information is associated with the data, and information contained in the protocol information dictates that the data not be executed.

In the case where the data to be transmitted to the reception terminal 120 is transmitted along with the protocol information, the protocol information unit 103 may generate protocol information for restricting transmission and execution of the data, and supplies the protocol information to a data generator 105.

The information storage unit 104 may store user data, the data to be transmitted to the reception terminal 120, and the data received from the NFC communication relay device 200.

The NFC data generator 105 generates the NFC data using the data to be transmitted to the reception terminal 120, which may be retrieved from the information storage unit 104 along with the profile information of the reception terminal 120 to receive the data.

The NFC data generator 105 may include protocol information received from the protocol information unit 103 in the generation of the NFC data.

The NFC transmitter 106 transmits the NFC data generated by the NFC data generator 105 to the NFC communication relay device 200 with NFC communication, and transmits the profile information of the reception terminal 120 to the NFC communication relay device 200 that may request the data.

The NFC terminal 100 having the above configuration may further include an encryption unit (not shown) for encrypting the data to be transmitted to the reception terminal 120 and supplying the encrypted data to the NFC data generator 105, a communication unit (not shown) for transmitting the decoding key to the reception terminal 120 (and may be performed with various communication techniques, such as, Bluetooth, ZigBee, an SMS or a MMS), and a decoder (not shown) for decoding the encrypted data received from the NFC communication relay device 200 using a decoding key received from the transmission terminal 110.

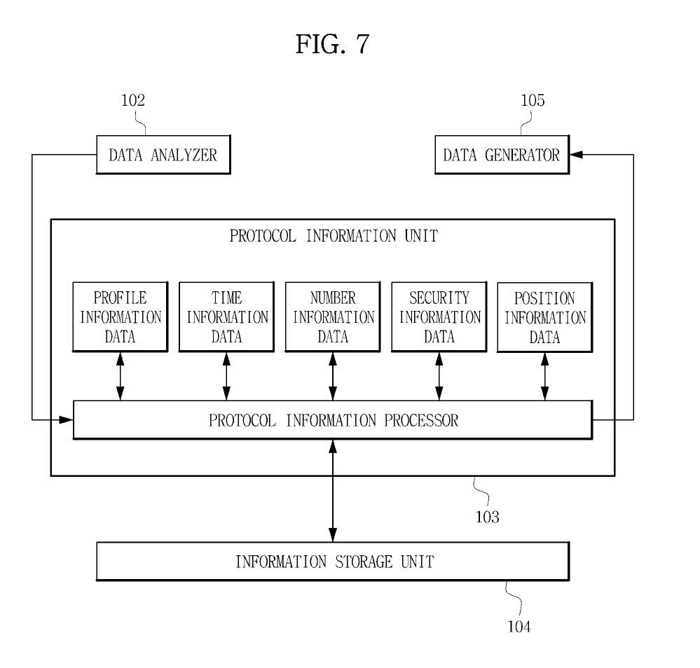

FIG. 7 is a schematic diagram illustrating a protocol information unit according to an exemplary embodiment of the present invention.

The protocol information unit 103 includes a protocol information processor to generate the information to restrict transmission and execution of the data to and in a reception terminal 120. As stated above, the profile information is associated with a reception terminal 120 to receive data. The protocol information may contain time information data, which is used to restrict and delete data from the transmission terminal 110, and restrict execution of the data. The protocol information may contain number information data, which is used to restrict and delete the data from the transmission terminal based on a parameter associated with the number, such as the size of the data or the amount of time the data has been accessed. The protocol information may also contain security information data, which is an encryption key for security of the data or available for access. The protocol information may also contain position information data, which restricts transmission and execution of the data based on a position of the receiver terminal 120.

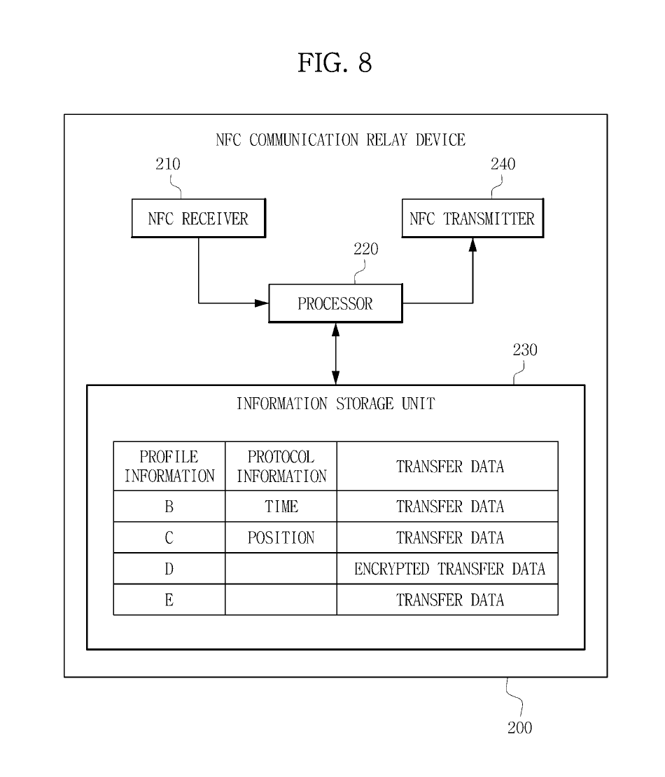

FIG. 8 is a schematic diagram illustrating a NFC communication relay device according to an exemplary embodiment of the present invention.

In FIG. 8, a NFC communication relay device 200 includes NFC receiver 210, a processor 220, an information storage unit 230, and a NFC transmitter 240.

A NFC receiver 210 receives data from the transmission terminal 110.

A processor 220 processes the data received from the transmission terminal 110 through the NFC receiver 210, maps the data (or the encrypted data) to the profile information of a reception terminal 120, and may store the data or the processed data in the information storage unit 230.

If protocol information is included along with the data, the processor 220 maps the protocol information to the data, and stores the mapped protocol information in the information storage unit 230.

If the reception terminal 120 requests the data (the request may include profile information associated with the reception terminal 120), the processor 220 retrieves the data (or the encrypted data) to be transmitted to the reception terminal 120 from the information storage unit 230 using the profile information from the reception terminal 120, and sends the retrieved data (or the encrypted data) to the NFC transmitter 240. The processor 220 determines whether the protocol information mapped to the retrieved data is present, and based on the protocol information, determines whether to transmit the data to the reception terminal 120 through the NFC transmitter 240, or restrict transmission.

The NFC transmitter 240 transmits the data (or the encrypted data) retrieved by the processor 220 to the reception terminal 120 via a communication technique, such as NFC.

Although the information storage unit 230 is shown as included in the NFC communication relay device 200, the information storage unit 230 may be included in a server connected to or accessible by the NFC communication relay device 200.

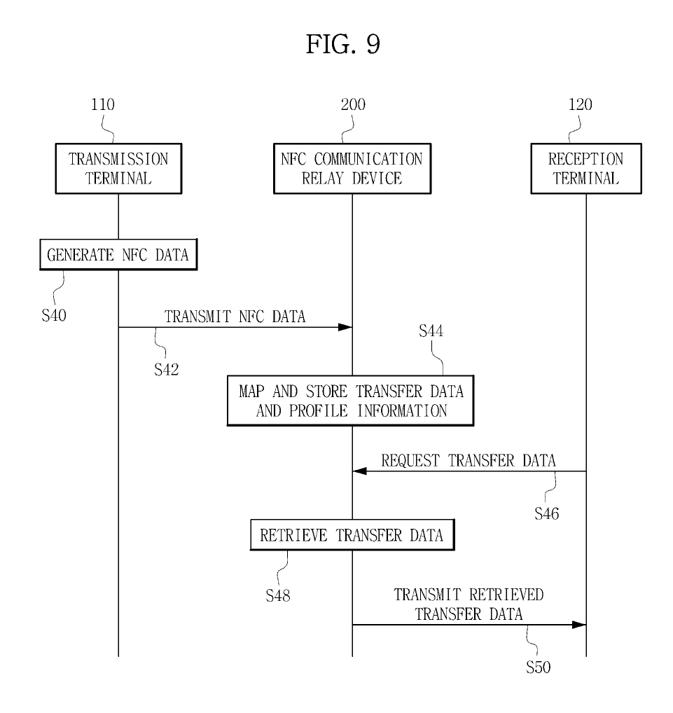

FIG. 9 is a flowchart illustrating a method for communicating between NFC terminals according to an exemplary embodiment of the present invention. The method shown in FIG. 9 will be described as if performed by the transmission terminal 110, reception terminal 120, and NFC communication relay device 200 as described above, but is not limited as such.

The transmission terminal 110 generates the data to be transmitted to the reception terminal 120, and incorporates along with the data the profile information of a reception terminal 120 that receives the data (S40), and transmits the data to the NFC communication relay device 200 with NFC communication (S42).

The profile information identifies the reception terminal 120 to receive the data, and information identifying the reception terminal 120 may be stored in the transmission terminal 110. The profile information of the reception terminal 120 may be a telephone number of the reception terminal 120 stored in an address book of the transmission terminal 110, a serial number of the reception terminal 120, a name, a nickname, an email address and an address of a user of the reception terminal 120. The profile information of the reception terminal 120 may be obtained from the address book stored in the information storage unit 104 of the transmission terminal 110 or the profile information data of the protocol information unit 103.

In Operation S40, the transmission terminal 110 generates the data to be transferred to the reception terminal 120 obtained from the information storage unit 104, and the profile information of the reception terminal 120 obtained from the information storage unit 104, and may also incorporate information from the protocol information unit 103.

The NFC communication relay device 200 stores the received data in the information storage unit 230. The data may be mapped to the profile information of the reception terminal 120, and this mapping may be stored in the information storage unit 230 (S44).

Thereafter, the reception terminal 120 to receive the data transmits its profile information to the NFC communication relay device 200, and may request data from the NFC communication relay device 200 (S46).

The NFC communication relay device 200 retrieves the data to be transmitted to the reception terminal 120 from the information storage unit 230 using the profile information of the reception terminal 120 (S48) and transmits the retrieved data to the reception terminal 120 (S50).

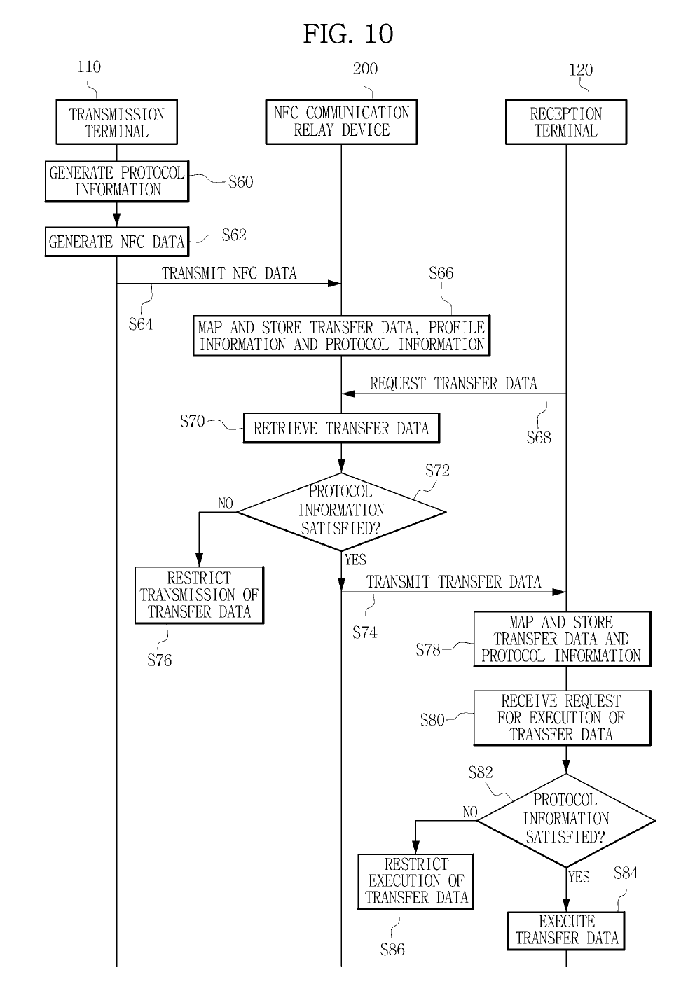

FIG. 10 is a flowchart illustrating a method for communicating between NFC terminals according to an exemplary embodiment of the present invention. The method shown in FIG. 10 will be described as if performed by the transmission terminal 110, reception terminal 120, and NFC communication relay device 200 as described above, but is not limited as such.

The transmission terminal 110 generates the protocol information for restricting transmission and execution of the data (S60).

In Operation S60, the transmission terminal 110 generates the protocol information with a parameter for restricting the transmission or execution of data sourced from the transmission terminal 110. This parameter may be one or more of various items associated with the data, such as, time information data, number information data, security information data, and the like.

The transmission terminal 110 generates data using the protocol information generated in Operation S60. This data may include the data to be transmitted to the reception terminal 120, the profile information of a reception terminal 120 to receive the data (S62). After this data is generated, the transmission terminal 110 transmits the generated data to the NFC communication relay device 200 with NFC communication (S64).

The NFC communication relay device 200 maps the data, the profile information of the reception terminal 120, and protocol information, and stores the data along with the mapping in the information storage unit 230 (S66).

The reception terminal 120 may request data from the NFC communication relay device 200 (S68).

The NFC communication relay device 200 retrieves data to from the information storage unit 230 using the profile information of the reception terminal 120 (S70). The profile information of the reception terminal 120 may be sent along with the request for data in operation S68. The NFC communication relay device 200 may restrict transmission of the data based on associated protocol information mapped to the reception terminal 120 (S72) which restricts transmission to a specific reception terminal 120 (S76). The protocol information may also be associated with a specific data item, thereby restricting the data item from being transmitted. Conversely, if no such protocol information exists or the protocol information allows data to be transmitted to the specific reception terminal 120, the data may be transmitted (S74).

For example, in a case where a transmission restriction time exists as protocol information for data transmitted from the transmission terminal 110, a determination as to whether a time when the reception terminal 120 requests the data from the NFC communication relay device 200 exceeds the transmission restriction time may be made. The data is transmitted to the reception terminal 120 if the time does not exceed the transmission restriction time, and the transmission of the data to the reception terminal 120 is restricted if the time exceeds the transmission restriction time. For example, if a transmission restriction time for disabling students to receive lecture materials after a lecture starts is set, students who arrive before the lecture has started may receive the lecture materials, but students who arrive after the lecture has started may not receive the lecture materials.

If a transmission restriction number that restricts the number of times a transmission of the data is permitted, is included with the protocol information when the transmission terminal 110 transmits the data to the NFC communication relay device 200, a determination as to whether the transmission restriction number is exceeded if the reception terminal 120 requests the data from the NFC communication relay device 200 is made. The data is transmitted to the reception terminal 120 if the transmission restriction number is not exceeded, and the transmission of the data to the reception terminal 120 is restricted if the transmission restriction number is exceeded. For example, in the case where a shop provides coupons to ten customers in order of arrival, an eleventh customer may not receive a coupon.

In the case where a distance between the transmission terminal 110 and the reception terminal 120 is included as the protocol information, the data is transmitted to the reception terminal 120 if the distance between the transmission terminal 110 and the reception terminal 120 is equal to or less than a reference value from the protocol information, and the transmission of the data to the reception terminal 120 is restricted if the distance between the transmission terminal 110 and the reception terminal 120 is greater than the reference value. For example, in a case where coffee coupons are provided to students who listen to a lecture from beginning to end after the lecture is finished, only students who are located a short distance from a professor may receive the coffee coupons.

In the case where the distance between the transmission terminal 110 and the reception terminal 120 and the transmission restriction time are transmitted as protocol information, the data is transmitted to the reception terminal 120 if the transmission restriction time has not been exceeded and the distance between the transmission terminal 110 and the reception terminal 120 is equal to or less than the reference value of the protocol information, and the transmission of the data to the reception terminal 120 is restricted if the transmission restriction time is exceeded or the distance between the transmission terminal 110 and the reception terminal 120 is greater than the reference value.

If the NFC communication relay device 200 transmits the retrieved data to the reception terminal 120 in Operation S74, the NFC communication relay device 200 transmits the protocol information along with the data. As explained above, the protocol information may be used to restrict the execution of data on a reception terminal 120.

The reception terminal 120 stores the data in the information storage unit 104 (S78).

The data and the protocol information may be mapped and stored if there exists protocol information from the received data (S78).

If a request for execution of the data is received from the terminal (S80), the reception terminal 120 may restrict execution of the data based on the protocol information being mapped to the data. The reception terminal 120 makes a determination if a condition associated with the protocol information is satisfied (S82). If NO, the data is not permitted to be executed (S86). If YES, the data is allowed to be executed (S84).

If an execution restriction time for restricting execution of the data is included along with the protocol information, a determination is made as to whether a time when execution of the data is requested exceeds the execution restriction time. The data is executed if the time does not exceed the execution restriction time, and execution of the data is restricted if the time exceeds the execution restriction time.

If an execution restriction number for restricting execution of the data is included along with the protocol information, a determination is made as to whether the number of times the data has been requested to be executed exceeds the execution restriction number. The data is executed if the number does not exceed the execution restriction number and execution of the data is restricted if the number exceeds the execution restriction number.

If position information for restricting execution of the data is included along with the protocol information, a determination is made as to whether a position where execution of the data is requested is beyond the confines of an execution restriction area. The data is executed if the position does not beyond the execution restriction area and execution of the data is restricted if the position is beyond the confines of the execution restriction area. For example, if the data which is permitted to be executed in an office is executed outside an office, the data may not be executed based on the protocol information.

If a reception terminal 120 satisfies the conditions of a protocol information, and the data is permitted to be executed, the reception terminal 120 may decode encrypted data using a symmetrical key included in the protocol information mapped to the data, if the data is encrypted by a symmetrical key. Conversely, this symmetrical key may be communicated through another technique, as described above

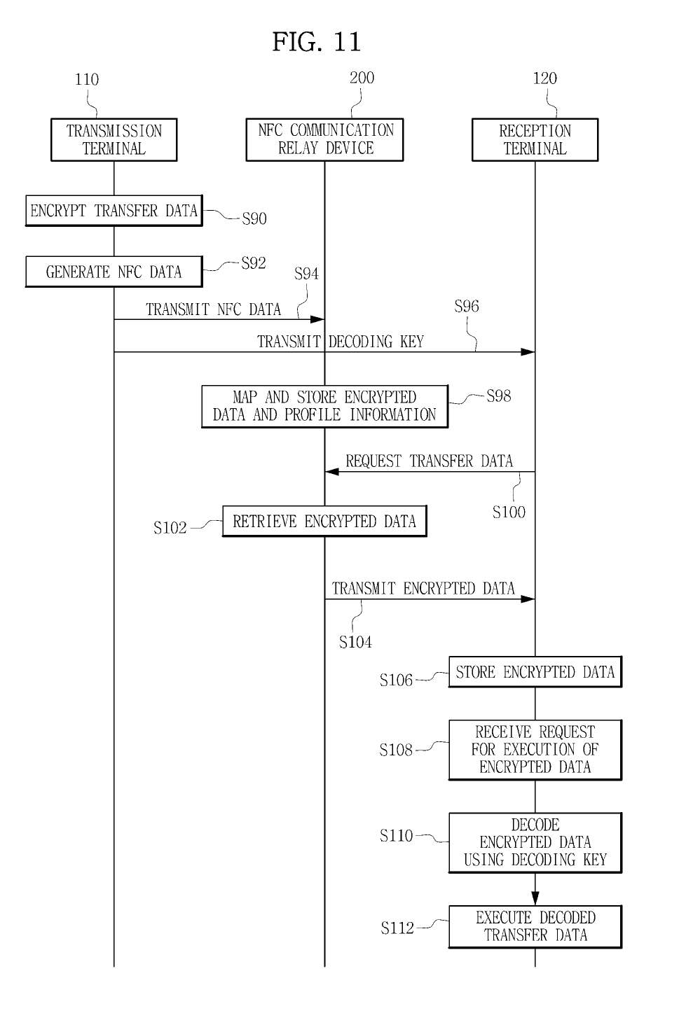

FIG. 11 is a flowchart illustrating a method for communicating between NFC terminals according to an exemplary embodiment of the present invention. The method shown in FIG. 11 will be described as if performed by the transmission terminal 110, reception terminal 120, and NFC communication relay device 200 as described above, but is not limited as such.

The transmission terminal 110 encrypts the data (S90), generates the data using the encrypted data and the profile information of a reception terminal 120 to receive the encrypted data, and transmits the generated data to the NFC communication relay device 200 with NFC communication (S94).

The transmission terminal 110 transmits a decoding key for decoding to the reception terminal 120 through short-range wireless communication such as Bluetooth or ZigBee, a SMS or a MMS (S96).

The NFC communication relay device 200 maps the encrypted data and the profile information of the reception terminal 120, both of which are included in the data transmitted from the transmission terminal 110, and stores the mapping, the encrypted data, and the profile information in the information storage unit 230 (S98).

The reception terminal 120 may request data from the NFC communication relay device, and may include along with the request profile information (S100).

The NFC communication relay device 200 retrieves the encrypted data from the information storage unit 230 using the profile information of the reception terminal 120 (S102), and transmits the retrieved encrypted data to the reception terminal 120 (S104).

The reception terminal 120 stores the encrypted data in the information storage unit 104 (S106).

If a request for executing the encrypted data is made (S108), the reception terminal 120 decodes the encrypted data using the decoding key and executes the decoded data (S112). In another example, and as described above, the determination of execution may be further made based on included parameters of the protocol information.

Thus, according to the above, it becomes possible to exchange information between the NFC terminals while increasing the capability of the NFC terminal.

In addition, it may become possible to transmit information or data without using an existing encryption authentication technique.

While the exemplary embodiments have been shown and described, it will be understood by those skilled in the art that various changes in form and details may be made thereto without departing from the spirit and scope of the present disclosure as defined by the appended claims.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A near field communication (NFC) terminal, comprising:
a NFC communication unit to communicate with a NFC communication relay device via NFC;
a processor to process data; and
a protocol information unit to augment the data with a profile information,
wherein the NFC communication unit communicates the data and the profile information via to the NFC communication relay device via NFC.

2. The terminal according to claim 1, wherein the NFC communication unit comprises a NFC receiver.

3. The terminal according to claim 2, wherein the NFC terminal receives the data and the profile information in response to a request to receive the data.

4. The terminal according to claim 3, wherein the data includes protocol information, the protocol information to set a condition for restricting transmission or execution of the data.

5. The terminal according to claim 4, wherein the protocol information is a time, location, or identification of the NFC terminal.

6. The terminal according to claim 1, wherein the NFC communication unit comprises a NFC transmitter.

7. The terminal according to claim 6, wherein the NFC terminal transmits the data and the profile information.

8. The terminal according to claim 7, wherein the data includes protocol information, the protocol information to set a condition for restricting reception or execution of the data with regard to a second NFC terminal.

9. The terminal according to claim 8, wherein the protocol information is a time, location, or identification of the second NFC terminal.

10. A method for providing communication between a first near field communication (NFC) terminal and a second NFC terminal, comprising:
at a NFC communication relay device, receiving data augmented with profile information;
at the NFC communication relay device, storing the data augmented with profile information;
at the NFC communication relay device, retrieving the data based on a request from the second NFC terminal; and
at the NFC communication relay device, transmitting the data to the second NFC terminal.

11. The method according to claim 10, wherein the data comprises protocol information.

12. The method according to claim 11, wherein after the second terminal requests data from the NFC relay device, determining whether the protocol information from the data matches protocol information from the request.

13. The method according to claim 12, wherein if the protocol information from the data matches the protocol information from the request, at the NFC relay device, transmitting data to the second NFC terminal.

14. The method according to claim 12, wherein if the protocol information from the data does not match the protocol information from the request, at the NFC relay device, restricting the transmission of data to the second NFC terminal.

15. The method according to claim 11, wherein if the protocol information from the data matches protocol information from the request at the second NFC terminal, executing the data, and if the protocol information from the data does not match protocol information from the request, restricting execution of the data.

16. The method according to claim 10, further comprising:
at the first NFC terminal, encrypting the data prior to transferring the data to the NFC relay device; and
at the first NFC terminal, transmitting a decoding key to decrypt the encrypted data.

17. The method according to claim 16, further comprising:
at the second NFC terminal, storing the encrypted data; and
at the second NFC terminal, decrypting the encrypted data with the decoding key.

18. A near field communication (NFC) relay device, comprising:
a NFC receiver to receive data and protocol information via NFC communication;
a NFC transmitter to transmit data via NFC communication;
a processor to process data; and
an information storage unit to store the received data,
wherein if the NFC relay device receives a request from a NFC terminal, the processor retrieves data from the information unit, and the NFC transmitter transmits the data to the NFC terminal.

19. The device according to claim 18, wherein the processor, based on the request, restricts the transmission of data.

20. The device according to claim 18, wherein the data comprises encrypted data.
